(19) United States
(12) Patent Application Publication
(10) Pub. No.: US 2026/0325257 A1
(43) Pub. Date: Oct. 22, 2026

(54) METHOD FOR MANUFACTURING A DENTAL PROSTHESIS PART, ADAPTER, BLANK AND SET OF ADAPTER AND BLANK, SET OF SEVERAL ADAPTERS

(71) Applicant: CERAMIST One GmbH, Wiesbaden (DE)

(72) Inventor: Frederic MÜLLER, Wiesbaden (DE)

(21) Appl. No.: 19/114,020

(22) PCT Filed: Dec. 12, 2023
(86) PCT No.: PCT/EP2023/085294

§ 371 Date: Mar. 21, 2025

(30) Foreign Application Priority Data
Dec. 15, 2022 (DE) 10 2022 133 401.5

(51) Int. Cl. A61C 5/77; A61C 13/00

(52) U.S. Cl. CPC A61C 5/77; A61C 13/0004; A61C 13/0022

(57) ABSTRACT

A method for manufacturing a dental prosthesis part that can be connected to a tooth stump, in particular a fixed dental prosthesis part includes manufacturing an adapter for a machine tool and a blank for the dental prosthesis part.

The present invention relates to methods for manufacturing a dental prosthesis part which can be connected to a tooth stump, as well as an adapter for a machine tool, a blank of a dental prosthesis part and a set comprising an adapter and a blank, as well as a set comprising several adapters.

Dental prosthesis parts are used to replace damaged or lost teeth or parts of teeth. Dental prosthesis parts can be divided into fixed and removable dental prosthesis parts. Removable dental prosthesis parts include dentures. Fixed dental prosthesis parts include crowns, partial crowns, bridges and veneers.

Crowns and bridges in particular are connected to existing teeth in the mouth. For this purpose, a dentist grinds/mills a tooth stump from an existing tooth. The shape and size of the tooth stump varies from tooth stump to tooth stump due to different tooth shapes, sizes and inclinations as well as manual processing. A conventional or digital impression is then taken of the tooth stump. Based on this impression, a suitable dental prosthesis part can be made, which is placed on the tooth stump and fixed in place. The dental prosthesis part is produced in several steps. First, the rough shape of the dental prosthesis part is milled out of a blank, cast or laser-sintered. The workpiece is then ground and polished. Finally, the dental prosthesis part is coated.

The manual production of a dental prosthesis part is very time-consuming. However, automating the manufacturing process is challenging, as each dental prosthesis part has to be made individually.

Known methods for manufacturing dental prosthesis parts are described in WO 98/03128 A1, U.S. Pat. No. 7,077,391 B2, WO 2009/070470 A1 and WO 2008/131159 A1. None of these processes offer sufficient automation. In all cases, manual reworking is necessary. DE 199 22 870 A1 only discloses a method for the automatic, individually adapted coloration, translucency, bright-ness and fluorescence of dental restorations.

Further methods are known from DE 10 2010 037 160 A1, DE 10 2016 203 055 A1, EP 1 729 667 B1 and WO 2009/073498 A1.

Therefore, the object of the invention was to increase the degree of automation of manufacturing processes for dental prosthesis parts.

This object is solved by a method according to claim 1.

The method for manufacturing a dental prosthesis part which can be connected to a tooth stump, in particular a fixed dental prosthesis part, has the following steps:
a) providing a stump data set with three-dimensional data on the shape and size of the tooth stump
b) producing an adapter for a machine tool using the stump data set, wherein the adapter has, in particular, a stump section which corresponds in shape and size to the tooth stump, and wherein the adapter has a coupling section which can be coupled to a clamping device of a machine tool
c) producing a blank using the stump data set, the blank having a recess which can at least partially accommodate the tooth stump
d) connecting the blank to the adapter, in particular the stump section of the adapter being at least partially accommodated by the recess in the blank
e) Clamping the coupling section in the clamping device of the machine tool
f) Additive and/or subtractive reworking of the blank into the dental prosthesis part by means of the machine tool
g) Removing the dental prosthesis part from the adapter

The method offers the advantage that the blank can be clamped in a machine tool by means of the adapter, whereby the position and orientation of the blank within the machine tool are known, as the blank is arranged on the adapter and the geometry of the adapter is known. In this way, the blank can be machined very precisely. Precise machining is even possible when the adapter with the blank is unclamped and clamped again, as the position and orientation of the blank within the machine tool are still predetermined by the geometry of the adapter and the known arrangement of the adapter within the machine tool. In addition, the blank can also be successively clamped in several different machine tools, whereby the position and orientation of the blank are clearly known in each case. This enables multiple machining of the blank. Manual reworking of a milled blank is thus avoided or at least considerably reduced, and the degree of automation increases. Due to the temporary connection with the adapter, the dental prosthesis part no longer needs to be reworked or hardly needs to be reworked after removal from the adapter.

In the case of a bridge, the dental prosthesis part is connected to several tooth stumps. In this case, the stump data set includes three-dimensional data on the shape and size of all tooth stumps and their arrangement in relation to each other. The adapter can then have several stump sections or several adapters can be provided. The blank then has several recesses that match the shape, size and relative arrangement of the several tooth stumps.

The steps of the method can, but do not necessarily have to, be carried out in the specified order. In particular, steps b) and c) can be carried out simultaneously or one after the other and in any order. The sequence of steps d) and e) is also arbitrary. Preferably, step a) is carried out before steps b) and c). It is also preferred that steps d) to g) are carried out after steps b) and c). Further preferably, step f) is carried out after steps d) and e). Further preferably, step g) is carried out after step f). Instead of a single clamping and subsequent reworking (steps e) and f)), the coupling section can also be unclamped and clamped several times (in the same or a different machine tool), whereby it is additively and/or subtractively reworked in the clamped state. This can be repeated as often as required without affecting the precision of the reworking.

In particular, a tooth stump is understood to be a body made from a (human) tooth, in particular in the shape of a truncated cone, on and/or to which a dental prosthesis part can be permanently arranged. In particular, the tooth stump is arranged in the mouth of a person to be treated.

A blank is understood to be a preliminary stage of the dental prosthesis part. The blank is therefore a semi-finished product. The blank can already have a shape that roughly corresponds to that of the dental prosthesis part to be manufactured, but it can also be block-shaped, for example. In any case, the blank has a recess for the tooth stump or the stump section of the adapter. In particular, the blank does not have a coupling section for coupling the blank to a clamping device of a machine tool, as the blank is temporarily connected to a clamping device via the adapter.

The recess is preferably larger than the stump section so that, for example, an adhesive can be arranged between the components to bond them together. However, at the preparation boundary, i.e. the transition between the stump section and the connecting section, the recess can be dimensioned so that the blank touches the stump section. This ensures clear positioning of the blank in relation to the adapter. Even when the dental prosthesis part is used later, it lies at the preparation margin on the tooth stump. Alternatively, it is also possible for the stump section to deviate in shape from the (real) tooth stump at the preparation margin and for the blank and adapter not to touch there. This prevents damage to the blank at this point and makes it easier to process the blank around this point.

It is possible within the scope of the method according to the invention that a blank has two (or more) recesses and two (or more) different adapters are provided, the stump sections of the adapters and the recesses of the blank being adapted to two (or more) different tooth stumps. In this way, for example, a large bridge can be produced which is to be fitted on two (or more) widely spaced tooth stumps.

The clamping device of the machine tool can also be referred to as a receptacle/chuck. In particular, it is a zero-point clamping system. The zero-point clamping system enables the position and orientation of the blank to be determined with particular precision, which has a positive effect on the reworking of the blank into the dental prosthesis part.

The machine tool is in particular a CNC machine, preferably a CNC machine for additive and/or subtractive machining of workpieces, for example a CNC milling machine.

In addition to the stump data set, other data sets can be used in the method, in particular a tooth data set comprising three-dimensional data on the shape and size of the dental prosthesis part, in particular on its outer surface (including occlusal surface, lip surface, tongue surface, occlusal surface, labial surface, lingual surface). Advantageously, the tooth data set is used to manufacture the blank in step c) and/or when reworking the blank in step f). In step c), a complete 3D model of the blank can be created by combining the stump data set with the tooth data set and the blank can be produced on this basis. In step f), for example, a block-shaped blank can be converted into the dental prosthesis part using the tooth data set.

The adapter in step b) and/or the blank in step c) is advantageously produced by casting and/or by subtractive processes, in particular milling, grinding and/or turning, and/or by additive processes, in particular laser sintering. Both the adapter and the blank are preferably in one piece. During casting, for example, a mold of the component to be produced can first be milled from a block of wax. The mold is then embedded, the wax is burned out and the liquid metal is poured into the hollow mold.

Advantageously, the adapter and/or the blank comprise ceramic, in particular zirconium dioxide and/or lithium disilicate, a metal and/or a metal alloy. If the adapter and/or blank are made entirely from a single material, they are particularly stable. Zirconium dioxide is a particularly stable material and is particularly suitable for larger dental prosthesis parts such as bridges. The materials used for the blank and the adapter are expensive. In some embodiments, a multi-part adapter is therefore produced in step b). Preferably, one part of the multi-part adapter has the stump section and another part of the multi-part adapter has the coupling section. The parts can be temporarily joined together, for example using an adhesive. In this way, the part with the coupling section can be used successively for different adapters, thereby achieving a cost saving. Accordingly, step b) may also involve using an existing part with the coupling section, additionally producing the part with the stump section and joining it to the other part to produce the adapter.

Steps b) and c) can each involve sintering the adapter or the blank. In this case, a green compact is first produced, for example by casting and/or milling, and the green compact is then sintered, producing the adapter or blank. The green compact shrinks during sintering and is therefore initially produced oversized. After sintering, the adapter or blank can be further processed, in particular subtractively and/or additively, to produce the desired final shape.

In advantageous embodiments, the stump data set is provided in step a) by recording the shape and size of the tooth stump and preferably also the relative arrangement of several tooth stumps. Alternatively, an existing stump data set can also be provided in step a). The shape and size of the tooth stump and optionally the relative arrangement of several tooth stumps are preferably recorded directly in the mouth of a person to be treated (intraoral scan) or by scanning a model (model scan), in particular a plaster model. An intraoral scanner can be used for this purpose.

For reworking the blank, it is advantageous if the blank and adapter are firmly connected to each other. Otherwise, there is a risk of the blank becoming detached from the adapter or being damaged during processing. In advantageous embodiments, the blank is connected to the adapter in step d) in a releasably adhesive manner, in particular by means of an adhesive and/or cement. An adhesive connection ensures a firm connection. Due to the detachability of the connection, the dental prosthesis part and adapter can be separated from each other largely non-destructively after reworking. Separation can be achieved, for example, by melting the adhesive.

Preferably, the shape and size of the recess in step c) is designed in such a way that an intermediate volume remains between the recess and stump section during the connection in step d), whereby the intermediate volume is filled with a connecting material, in particular an adhesive and/or cement. The intermediate volume creates a defined space in which the connecting material is arranged and can connect the blank to the adapter. This creates a secure connection.

As already mentioned, the removal of the dental prosthesis part from the adapter should be as non-destructive as possible. In advantageous embodiments, the dental prosthesis part is therefore removed from the adapter in step g) by melting the adhesive connection, in particular in an oven. Preferably, the adapter with the dental prosthesis part attached to it is therefore first removed from the machine tool, i.e. removed from the clamping device, and the adapter and dental prosthesis part are then separated from each other.

In advantageous embodiments, the additive reworking in step f) comprises coating and/or the subtractive reworking in step f) comprises milling, grinding and/or polishing. Coating (veneering) is preferably the last work step. For coating as well as for milling, grinding and polishing, it is advantageous if the exact position and orientation of the blank in the machine tool is known, which is the case due to the adapter.

In advantageous embodiments, steps b), c) and d) are combined in one step. The adapter and blank are produced in one piece as an adapter blank part, preferably by casting and/or by subtractive processes, in particular milling, grinding and/or turning, and/or by additive processes. The adapter then has no stump section. The combined adapter/blank part is manufactured using the stump data set. The blank already has a recess that can at least partially accommodate the tooth stump. The adapter blank part has a coupling section that can be clamped in the clamping device of the machine tool in step e). The blank can then be converted into the dental prosthesis part. Preferably, the adapter blank part is sintered before or after reworking. In these embodiments, the dental prosthesis part is preferably removed from the adapter by machining after completion of the reworking and in particular in the same machine tool.

The object of the invention is also fulfilled by an adapter for a machine tool, in particular produced by step b) of the method according to the above description, having a stump section which corresponds in shape and size to a tooth stump, and a coupling section which can be coupled to a clamping device of a machine tool. The stump section corresponds in particular in shape and size to an individual tooth stump.

The coupling section of the adapter has, in particular, a cylindrical shape with a circumferential groove and, in particular, a hemispherical end. This shape is suitable for many machine tool clamping devices, which enables the adapter to be used in many different machine tools. In general, however, the coupling section can have any shape and size suitable for the clamping device of a particular machine tool. The advantages according to the invention then arise in particular when the adapter is used together with one or more suitable machine tools.

The connecting section is preferably curved, i.e. in particular not straight, which simplifies subsequent machining, including coating of the blank, as the individual tools of a machine tool have better access to the relevant areas of the blank. However, a straight design of the connecting section may be sufficient, particularly for single crowns, and the connecting section itself is then easier to manufacture.

A blank of a dental prosthesis part can be temporarily and detachably attached to the stump section. This allows the blank to be clamped in a machine tool, whereby the position and orientation of the blank within the machine tool is known, as the blank is arranged on the adapter and the geometry of the adapter is known. In this way, the blank can be machined very precisely. Precise machining is even possible when the adapter with the blank is unclamped and clamped again, as the position and orientation of the blank within the machine tool are still predetermined by the geometry of the adapter and its unique arrangement within the machine tool. In addition, the blank can also be successively clamped in several different machine tools, whereby the position and orientation of the blank are clearly known in each case. This enables multiple machining of the blank. Manual reworking of a milled blank is thus avoided or at least considerably reduced.

The stump section and/or the coupling section preferably forms one end of the adapter. If the adapter has only a stump section and only a coupling section, the adapter is preferably elongated and has two ends.

Dental prosthesis parts also include bridges. A bridge bridges several adjacent teeth. A bridge is fixed to several tooth stumps. So that a bridge can also be produced precisely, the adapter advantageously has several stump sections, with each stump section corresponding in shape and size to a different tooth stump. A bridge blank can then be arranged on the stump sections. The relative arrangement of the tooth stumps to each other is determined, in particular like the shape and size of the individual tooth stumps, using the stump data set.

The adapter is preferably in one piece. This makes the adapter very stable and holds the blank precisely in the intended position. This enables precise reworking of the blank. Alternatively, the adapter can be in several parts. Preferably, one adapter part of the multi-part adapter then has the stump section and another adapter part of the multi-part adapter has the coupling section. The adapter part with the coupling section can then be used with several different adapter parts with a stump section, thereby achieving a cost saving in the manufacture of the adapter.

Advantageously, the adapter comprises ceramic, in particular zirconium dioxide and/or lithium disilicate, a metal and/or a metal alloy. If the adapter is made entirely from one material, it is particularly stable. Zirconium dioxide is a particularly stable material and is particularly suitable for larger dental prosthesis parts such as bridges.

The adapter can be further formed by the advantageous embodiments described above.

The object of the invention is also solved by a blank of a dental prosthesis, in particular produced by step c) of the method described above, with a recess which can at least partially accommodate a tooth stump. The recess enables the blank to be temporarily and detachably attached to an adapter, in particular the adapter described above, and then to be precisely reworked in a machine tool to form a dental prosthesis part.

The blank can be further formed by the advantageous embodiments described above.

The object of the invention is also solved by a set comprising at least one adapter described above and at least one blank according to the above description, wherein the stump section of at least one adapter and the recess of at least one blank are adapted to the same tooth stump. This ensures that the blank can be temporarily and detachably attached to the stump section. This allows the blank to be clamped in a machine tool, whereby the position and orientation of the blank within the machine tool is known. In this way, the blank can be machined very precisely. In addition, the blank can also be clamped in several different machine tools one after the other. This enables multiple machining of the blank. Manual reworking of a milled blank is thus avoided.

It is possible that a blank has two (or more) recesses and two (or more) different adapters are provided, whereby the stump sections of the adapters and the recesses of the blank are adapted to two (or more) different tooth stumps. In this way, for example, a large bridge can be made which is to be fitted on two (or more) widely spaced tooth stumps.

The object of the invention is also solved by a set of several adapters according to the above description, wherein the coupling section is identical for each adapter and the stump sections of the adapters are different, in particular adapted to different tooth stumps. Due to their identical coupling sections, the adapters can all be used with the same clamping device of a machine tool. At the same time, the adapters are individually adapted to a given tooth stump. In this way, dental prosthesis parts for different tooth stumps can be produced in the same machine tool.

The object of the invention is further solved by a method for producing a dental prosthesis part which can be connected to a tooth stump, in particular a fixed dental prosthesis part, comprising the following steps:
aa) providing a stump data set with three-dimensional data on the shape and size of the tooth stump
bb) producing an adapter blank part comprising a blank and an adapter connected in one piece to the blank, wherein the blank has a recess which can at least partially receive the tooth stump and wherein the adapter has a coupling section which can be coupled to a clamping device of a machine tool
cc) clamping the coupling section in the clamping device of the machine tool
dd) additive and/or subtractive reworking of the blank into the dental prosthesis part by means of the machine tool
ee) removing the dental prosthesis part from the adapter

The method also offers the above-mentioned advantages, in particular the possibility of precise machining of the blank and the possibility of machining and also multiple machining of the blank in one or more machine tools. This method can also be further developed by the advantageous embodiments described above.

The object of the invention is also solved by the adapter blank part produced in step bb).

Preferably, the adapter blank part is sintered, in particular after step bb) and/or before step cc). This causes the adapter blank part to shrink, which is already taken into account during manufacture in step bb).

The invention is illustrated and explained below by way of example with reference to the drawings. Shown are in

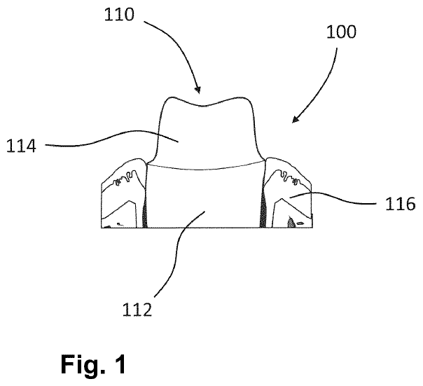

FIG. 1: a tooth stump in a mouth of a person to be treated in a schematic representation

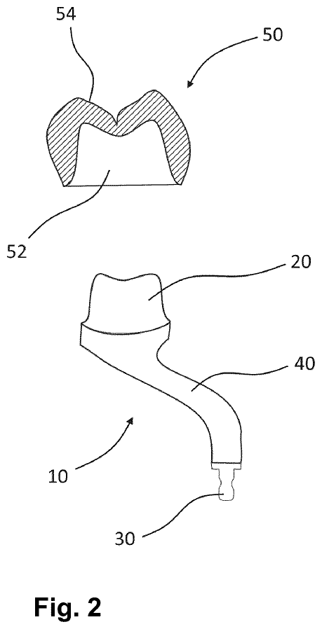

FIG. 2: a set comprising an adapter and a blank, partially in section, in a schematic representation

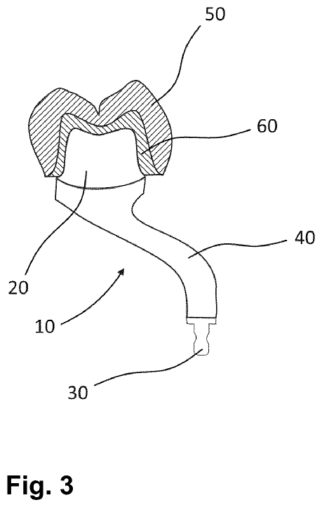

FIG. 3: the adapter and the blank of FIG. 2 in a connected state, partially in section, in a schematic representation

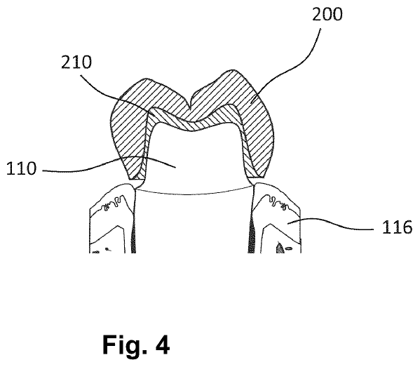

FIG. 4: the tooth stump of FIG. 1 with a dental prosthesis part, partially in section, in a schematic representation

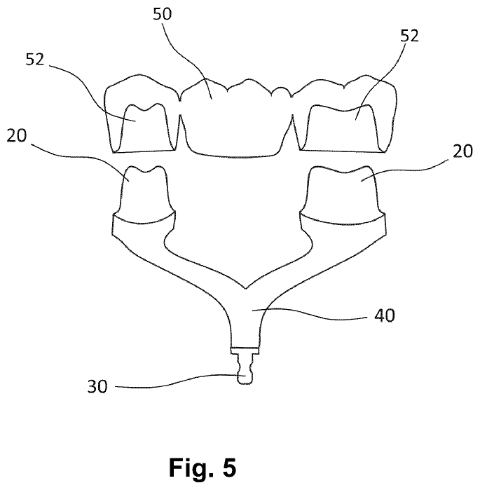

FIG. 5: a further embodiment of a set consisting of an adapter and a dental prosthesis part in a schematic representation

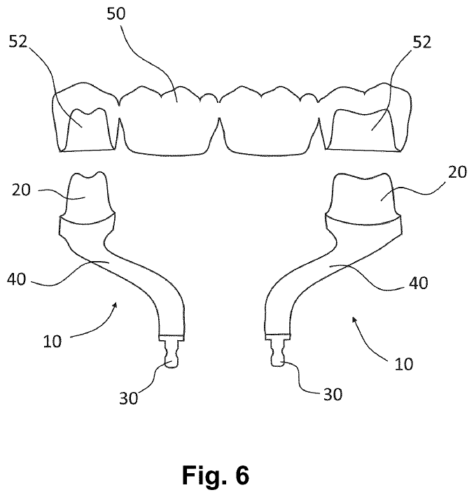

FIG. 6: another embodiment of a set consisting of an adapter and a dental prosthesis part in a schematic representation

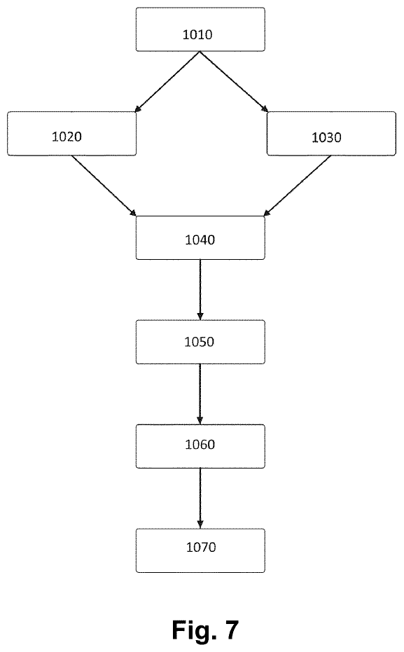

FIG. 7: schematic representation of the process sequence of an embodiment of the method according to the invention

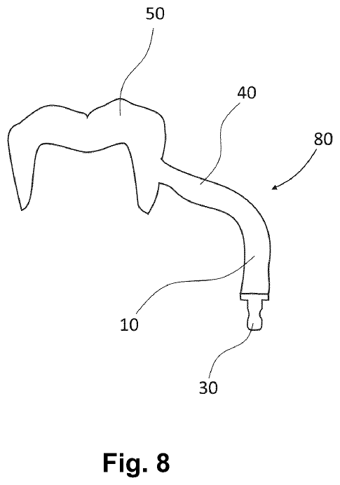

FIG. 8: an embodiment of an adapter blank part in a schematic representation

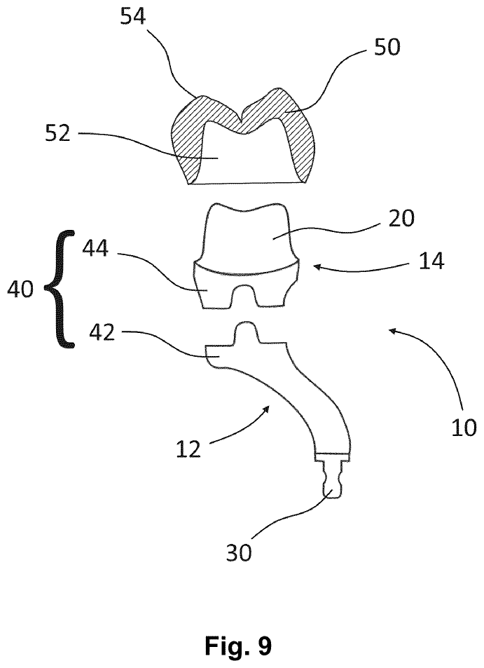

FIG. 9: a set of an adapter and a blank, partially in section, in a schematic representation

FIG. 1 shows a schematic section of a jaw 100 of a person to be treated. A tooth stump 110 is arranged in the jaw 100, which has been ground from an existing tooth by a dentist. The tooth stump 110 has approximately the shape of a truncated cone. In the lower region 112, the tooth stump 110 is surrounded by gums 116. The upper region 114 of the tooth stump 110 is to be provided with a crown (not shown here).

The shape and size of the tooth stump 110 can be measured, for example by means of an intraoral 3D scan. This scan provides a stump data set with three-dimensional data that provides information about the shape and size of the tooth stump 110.

An adapter 10, as shown in FIG. 2, can then be produced on the basis of this data. The adapter 10 comprises a stump section 20 which corresponds in shape and size to the tooth stump 110 of FIG. 1. The adapter 10 further comprises a coupling section 30, which is designed such that it can be coupled to a clamping device of a machine tool (not shown), in particular a quick-clamping system. In the embodiment shown, the coupling section 30 is designed such that it can be coupled to a zero-point clamping system.

The stump section 20 and the coupling section 30 are arranged at opposite ends of the adapter 10 and are connected to each other by a connecting section 40.

The coupling section 30 and the connecting section 40 are also milled on the basis of three-dimensional data. The coupling section 30 of different adapters 10 is identical. The adapters 10 then differ in terms of their stump sections 20 and optionally also in terms of their connecting sections 40.

The adapter 10 was produced from a solid material by milling. For this purpose, the three-dimensional data of the stump data set is combined with three-dimensional data of the coupling section 30 and the connecting section 40 to form a 3D model. This 3D model then forms the basis for manufacturing the adapter 10.

FIG. 2 also shows a blank 50. The blank 50 was also manufactured using the stump data set and has a recess 52 and an outer surface 54. The recess 52 is designed on the basis of the stump data set in terms of size and shape such that it can accommodate the stump section 20 or the tooth stump 110, whereby the recess 52 is larger than the stump section 20 so that an intermediate volume remains.

In the embodiment shown, the mold of the outer surface 54 was manufactured using a tooth data set. The tooth data set comprises three-dimensional data of the desired shape and size of the dental prosthesis part (not shown here). In other embodiments, the outer surface 54 of the blank 50 may be block-shaped.

The adapter 10 and the blank 50 are then joined together (FIG. 3). For this purpose, the stump section 20 is arranged in the recess 52. The intermediate volume is filled with a soluble adhesive 60. The adapter 10 and the blank 50 are connected to each other in a detachable and adhesive manner by the adhesive 60. In this state, the composite of adapter 10 and blank 50 can be arranged in one or successively in several machine tools. There, the blank 50 is additively and/or subtractively processed into a dental prosthesis part 200 (see FIG. 4), in this case a crown. Due to the known shape and size of adapter 10 and blank 50 as well as the exact arrangement of adapter 10 in the zero-point clamping system of the machine tool, the blank 50 can be machined very precisely.

Once the blank 50 has been reworked into the dental prosthesis part 200, the dental prosthesis part 200 is detached from the adapter 10. In the case of a fusible adhesive 60, the composite of adapter 10 and dental prosthesis part 200 can be heated in an oven. After heating, the dental prosthesis part 200 can be separated from the adapter 10. The dental prosthesis part 200 can then be arranged directly on the tooth stump 110 and bonded to it, for example using cement 210 (FIG. 4).

FIG. 5 shows a further embodiment of a set comprising an adapter 10 and a blank 50. In this embodiment, the blank 50 is intended for the manufacture of a bridge as dental prosthesis part 200. The adapter 10 comprises a coupling section 30 with which it can be clamped in a clamping device of a machine tool.

The adapter 10 further comprises a connecting section 40, which is Y-shaped, i.e. forks. At the single end, the connecting section 40 is connected to the coupling section 30. A stump section 20 is provided at each of the two other ends. The shape and size of the stump sections 20 and their relative arrangement are adapted to two tooth stumps (not shown here). The blank 50 has two recesses 52 and is connected to both stump sections 20. The coupling section 30 can then be clamped in the clamping device and the blank 50 can be additively and/or subtractively converted into a bridge.

The bridge is then separated from the adapter 10 and can be inserted into the mouth of a person to be treated.

FIG. 6 shows another embodiment of a set. The set is used to make a large bridge which, when used as intended, is placed on two tooth stumps (not shown here), between which there are two further empty tooth positions. In this embodiment, the set comprises two adapters 10 and a blank 50. Each of the adapters 10 comprises a stump section 20 corresponding in shape and size to one of the two tooth stumps. Both adapters 10 each comprise a coupling section 30, which are designed in such a way that they can be coupled to a clamping device of a machine tool (not shown) in such a way that the two stump sections 20 are positioned and oriented in such a way as to correspond to the situation in the patient's mouth.

In this embodiment, the blank 50 comprises two recesses 52, one for each of the two stump sections 20. The recesses 52 are positioned in such a way that they can simultaneously receive one of the two stump sections. In this way, the blank 50 can be connected to both adapters 10 at the same time. The position and orientation of the blank 50 is then known in the machine tool and the blank can be machined very precisely.

FIG. 7 schematically shows the process sequence of a method for manufacturing a dental prosthesis part that can be connected to a tooth stump. In step 1010, the shape and size of the tooth stump is first recorded, thereby providing a stump data set. Then, using the stump data set, an adapter for a machine tool is produced in step 1020, wherein the adapter has a stump section which corresponds in shape and size to the tooth stump, and wherein the adapter has a coupling section which can be coupled to a clamping device of a machine tool. In parallel, in step 1030, a blank of the dental prosthesis part is also produced using the stump data set, wherein the blank has a recess which can at least partially accommodate the tooth stump.

The adapter and the blank are joined together in step 1040, wherein the stump section of the adapter is at least partially received by the recess of the blank. Then, in step 1050, the coupling section of the adapter is clamped in the clamping device of the machine tool.

The blank is then additively and/or subtractively converted into the dental prosthesis part in step 1060 by means of the machine tool. Among other things, the blank is coated.

In step 1070, the finished dental prosthesis part is removed from the adapter. The dental prosthesis part can then be used, i.e. inserted into the mouth of a person to be treated.

FIG. 8 shows an adapter blank part 80 with an adapter 10 and a blank 50. Adapter 10 and blank 50 are joined together in one piece. In this embodiment, the adapter 10 does not have a stump section. Rather, the adapter 10 is connected at one end to the blank 50 and at the other end the adapter 10 has a coupling section 30, which is designed in such a way that it can be coupled to a clamping device of a machine tool (not shown). A connecting section 40 connects the two ends of the adapter 10.

Due to the known shape and size of the adapter blank part 80 and the exact arrangement of the adapter blank part 80 in the machine tool, the blank 50 can be machined very precisely. In addition, the adapter blank part 80 can be removed and reinserted as often as required without affecting the precision of the machining.

The set shown in FIG. 9 comprises an adapter 10 and a blank 50. The blank 50 comprises a recess 52 for a tooth stump (not shown here) and an outer surface 54, which is to be reworked.

In this embodiment, the adapter 10 comprises several parts. A first adapter part 12 comprises the coupling section 30 and a first connecting part 42. A second adapter part 14 comprises the stump section 20 and a second connecting part 44. The connecting parts 42, 44 are complementary to each other and can be temporarily connected to each other, for example by means of an adhesive. Together they form the connecting section 40 of the adapter 10. Due to the multiple parts, the first adapter part 12 can also be connected to other second adapter parts 14, which are adapted to other tooth stumps, and can thus be reused.

### LIST OF REFERENCE SYMBOLS

10 Adapter
12 First adapter part
14 Second adapter part
20 Stump section
30 Coupling section
40 Connecting section
42 First connecting part
44 Second connecting part
50 Blank
52 Recess
54 Outer surface
60 Adhesive
80 Adapter blank part
100 Jaw
110 Tooth stump
112 Lower area
114 Upper area
116 Gums
200 Dental prosthesis part
210 Cement

1. A method for manufacturing a dental prosthesis part that can be connected to a tooth stump, comprising the following steps:
a) providing a stump data set with three-dimensional data on the shape and size of the tooth stump;
b) manufacturing an adapter for a machine tool using the stump data set, wherein the adapter has a stump section which corresponds in shape and size to the tooth stump, and wherein the adapter has a coupling section which can be coupled to a clamping device of a machine tool;
c) manufacturing a blank using the stump data set, wherein the blank has recess that can at least partially receive the tooth stump;
d) connecting the blank to the adapter wherein the stump section of the adapter is at least partially received by the recess of the blank;
e) clamping the coupling section in the clamping device of the machine tool;
f) additive and/or subtractive reworking of the blank into the dental prosthesis part by the machine tool; and
g) removing the dental prosthesis part from the adapter.

2. The method according to claim 1, wherein the adapter in step b) and/or the blank in step c) is/are produced by casting, machining, grinding and/or turning, and/or by additive methods.

3. The method according to claim 1, wherein the stump data set is provided in step a) by determining the shape and size of the tooth stump.

4. The method according to claim 3, the shape and size of the tooth stump are determined directly in the mouth of a person to be treated or in that the shape and size of the tooth stump are determined by scanning a model.

5. The method according to claim 1, wherein the blank is detachably adhesively bonded to the adapter in step d).

6. The method according to claim 1, wherein the recess in step c) is designed in terms of shape and size such that, when connecting in step d), an intermediate volume remains between the recess and the stump section and wherein the intermediate volume is filled with a connecting material.

7. The method according to claim 1, wherein the dental prosthesis part is removed from the adapter in step g) by melting the adhesive bond.

8. The method according to claim 1, wherein the additive reworking in step f) comprises coating and/or that the subtractive reworking in step f) comprises milling, grinding and/or polishing.

9. The method according to claim 1, wherein steps b), c) and d) are combined and adapter and blank are manufactured in one piece.

10. An adapter for a machine tool comprising a stump section which corresponds in shape and size to a tooth stump and a coupling section which can be coupled to a clamping device of a machine tool.

11. The adapter according to claim 10, wherein the adapter has a plurality of stump sections each stump section corresponding in shape and size to a different tooth stump and/or in that the adapter is multi-part, wherein one adapter part of the multi-part adapter has the stump section and another adapter part of the multi-part adapter has the coupling section.

12. A blank of a dental prosthesis part produced using stump data set with three-dimensional data on the shape and size of a tooth stump, wherein the blank has a recess which can at least partially receive a tooth stump.

13. A set comprising:
at least one adapter according to claim 10; and
at least one blank produced using stump data set with three-dimensional data on the shape and size of the tooth stump, wherein the blank has a recess which can at least partially receive the tooth stump,
wherein the stump section of the at least one adapter and the recess of the at least one blank are adapted to the same tooth stump.

14. The set according to claim 13, wherein the set comprises at least one more adapter, wherein the coupling section is identical for each adapter and the stump sections of the adapters are different.
